(19) United States
(12) Patent Application Publication
(10) Pub. No.: US 2022/0270539 A1
(43) Pub. Date: Aug. 25, 2022

(54) DISPLAY DRIVER INTEGRATED CIRCUIT, IMAGE PROCESSOR, AND OPERATION METHOD THEREOF

(71) Applicant: Novatek Microelectronics Corp., Hsinchu (TW)

(72) Inventors: Yu-Tsung Lu, Hsinchu City (TW); Chih-Cheng Chuang, Tainan City (TW)

(73) Assignee: Novatek Microelectronics Corp., Hsinchu (TW)

(21) Appl. No.: 17/676,854

(22) Filed: Feb. 22, 2022

Related U.S. Application Data
(60) Provisional application No. 63/151,808, filed on Feb. 22, 2021.

(51) Int. Cl. G09G 3/20

(52) U.S. Cl. CPC G09G 3/2096; G09G 2340/045; G09G 2370/10

(57) ABSTRACT

A display driver integrated circuit, an image processor, and an operation method thereof are provided. The display driver integrated circuit includes a receiving circuit, a memory unit, and a foveated rendering circuit. The receiving circuit receives a first image and a second image from an image providing circuit. The memory unit stores the first image and the second image.

The foveated rendering circuit is coupled to the memory unit. The foveated rendering circuit generates an output image to be displayed by performing image processing based on the first image and the second image. The first image is with respect to a foveated area of the output image. The receiving circuit receives at least a part of one of the first image and the second image before the other one of the first image and the second image is completely received.

### CROSS-REFERENCE TO RELATED APPLICATION

This application claims the priority benefit of U.S. Provisional Application No. 63/151,808, filed on Feb. 22, 2021. The entirety of the above-mentioned patent application is hereby incorporated by reference herein and made a part of this specification.

### BACKGROUND

### Technical Field

The disclosure relates to data transmission, and more particularly to a display driver integrated circuit, an image processor, and an operation method thereof.

### Description of Related Art

Foveated rendering is a new image computing technology to reduce data amount of image detail which will not be noticed by user. When the human eye sees something, not the entire field of view is clear, but the center point is clear, and the field of view becomes blurrier closer to the sides. Therefore, in displaying images on a screen, only a foveated area of a screen where the human eye is foveating, usually a center area of the screen or a dynamically changing area determined based on an eye-tracking signal, is necessary to have the highest image resolution and the resolution in the area outside of the foveated area can be reduced. Therefore, the amount of transmitted data between the screen and a host device providing image data and the computational load can be greatly reduced by reducing the resolution of images around the foveated point. The foveated rendering technology is mainly applied in an augmented reality (AR) device and a virtual reality (VR) device that integrates an eye tracking technology.

FIG. 1 is a schematic diagram of a display system deploying a foveated rendering technology. The display system of FIG. 1 includes an application processor (AP) 110 and a display driver integrated circuit 120 driving a display panel. The application processor 110 may define a foveated area F11 in an original image IMG11. The application processor 110 may crop out a cropped image HD1 from the foveated area F11. The application processor 110 may also scale down the original image IMG11, that is, reduce the resolution of the original image IMG11, to generate a downscaled image LD1. The application processor 110 may transmit the downscaled image LD1 and the cropped image HD1 to a display driver integrated circuit 120. By reducing the resolution of the original image IMG11, the amount of transmitted data is greatly reduced.

After receiving the downscaled image LD1 and the cropped image HD1, the display driver integrated circuit 120 may scale up the downscaled image LD1, that is, increase the resolution of the downscaled image LD1, to generate an upscaled image IMG12. The display driver integrated circuit 120 may merge or blend the cropped image HD1 into a foveated area F12 of the upscaled image IMG12 to generate an output image to be displayed.

The application processor 110 issues an image write command to the display driver integrated circuit 120 to transmit the cropped image HD1 and the downscaled image LD1 to the display driver integrated circuit 120. Generally speaking, the application processor 110 completely transmits an image to the display driver integrated circuit 120 before starting to transmit another image. For example, the application processor 110 first completely transmits the cropped image HD1 to the display driver integrated circuit 120, and then starts to transmit the downscaled image LD1 to the display driver integrated circuit 120. Each image includes multiple lines, and each line includes multiple pixel data. After receiving at least one line of the downscaled image LD1, the display driver integrated circuit 120 may scale up the at least one line of the downscaled image LD1 to generate multiple corresponding lines of the upscaled

After the application processor 110 issues the image write command, the display driver integrated circuit 120 can only start to output the output image to be displayed to a display panel (not shown) after a period of time as a latency. The latency includes at least a transmission time of the image write command, a transmission time of the complete cropped image HD1, a transmission time of a first line of the downscaled image LD1, and an upscaled computing time for processing the first line of the downscaled image LD1. The latency becomes longer as the size of the cropped image HD1 increases. In a case where the sizes of the cropped image HD1 and the downscaled image LD1 do not change, in order to shorten the latency, the transmission speed of a transmission interface between the application processor 110 and the display driver integrated circuit 120 needs to be increased.

Although the foveated rendering technology can reduce the amount of transmitted data, the latency may not meet the application requirements of an AR product or a VR product. If the latency is to be reduced to meet the application requirements of the AR (or the VR) product, the transmission speed (or the bandwidth) of the transmission interface between the application processor 110 and the display driver integrated circuit 120 needs to be greatly increased. In fact, increasing the transmission speed (or the bandwidth) of the transmission interface without limit is impractical.

It should be noted that the content of the “Description of Related Art” section is used to help understand the disclosure. Part of the content (or all of the content) disclosed in the “Description of Related Art” section may not be the conventional technology known to persons skilled in the art. The content disclosed in the “Description of Related Art” section does not represent that the content is already known to persons skilled in the art before the application of the disclosure.

### SUMMARY

The disclosure provides a display driver integrated circuit, an image processor, and an operation method thereof to effectively reduce a latency.

In an embodiment of the disclosure, the display driver integrated circuit includes a receiving circuit, a memory unit, and a foveated rendering circuit. The receiving circuit is configured to receive a first image and a second image from an image providing circuit. The memory unit is configured to store the first image and the second image. The foveated rendering circuit is coupled to the memory unit. The foveated rendering circuit is configured to generate an output image to be displayed by performing image processing based on the first image and the second image. The first image is with respect to a foveated area of the output image. The receiving circuit receives at least a part of one of the first image and the second image before other one of the first image and the second image is completely received.

In an embodiment of the disclosure, the operation method of the display driver integrated circuit includes the following steps. A first image and a second image are received from an image providing circuit by a receiving circuit of the display driver integrated circuit. The receiving circuit receives at least a part of one of the first image and the second image before other one of the first image and the second image is completely received. The first image and the second image are stored to a memory unit. Image processing is performed based on the first image and the second image to generate an output image to be displayed. The first image is with respect to a foveated area of the output image.

In an embodiment of the disclosure, the image processor includes a digital signal processing circuit, a memory unit, and a transmitting circuit. The digital signal processing circuit is configured to generate a first image and a second image based on an original image. The first image is a cropped image with respect to a foveated area of the original image, and the second image is a downscaled image through scaling down the original image. The memory unit is coupled to the digital signal processing circuit. The memory unit is configured to store the first image and the second image. The transmitting circuit is coupled to the memory unit. The transmitting circuit is configured to transmit the first image and the second image to a display driver integrated circuit. The transmitting circuit transmits at least a part of one of the first image and the second image before other one of the first image and the second image is completely transmitted.

In an embodiment of the disclosure, the operation method of the image processor includes the following steps. A first image and a second image are generated based on an original image by a digital signal processing circuit. The first image is a cropped image with respect to a foveated area of the original image, and the second image is a downscaled image through scaling down the original image. The first image and the second image are stored by a memory unit. The first image and the second image are transmitted to a display driver integrated circuit by a transmitting circuit of the image processor. The transmitting circuit transmits at least a part of one of the first image and the second image before other one of the first image and the second image is completely transmitted.

Based on the above, the image providing circuit (for example, the image processor) according to the embodiments of the disclosure may generate the cropped image (the first image) and the downscaled image (the second image) based on the original image. The image processor may first transmit at least a part of one of the cropped image and the downscaled image to the display driver integrated circuit before the other one of the cropped image and the downscaled image is completely transmitted to the display driver integrated circuit. Therefore, the latency can be effectively reduced.

In order for the features and advantages of the disclosure to be more comprehensible, specific embodiments are described in detail below in conjunction with the accompanying drawings.

### BRIEF DESCRIPTION OF THE DRAWINGS

FIG. 1 is a schematic diagram of a display system deploying a foveated rendering technology.

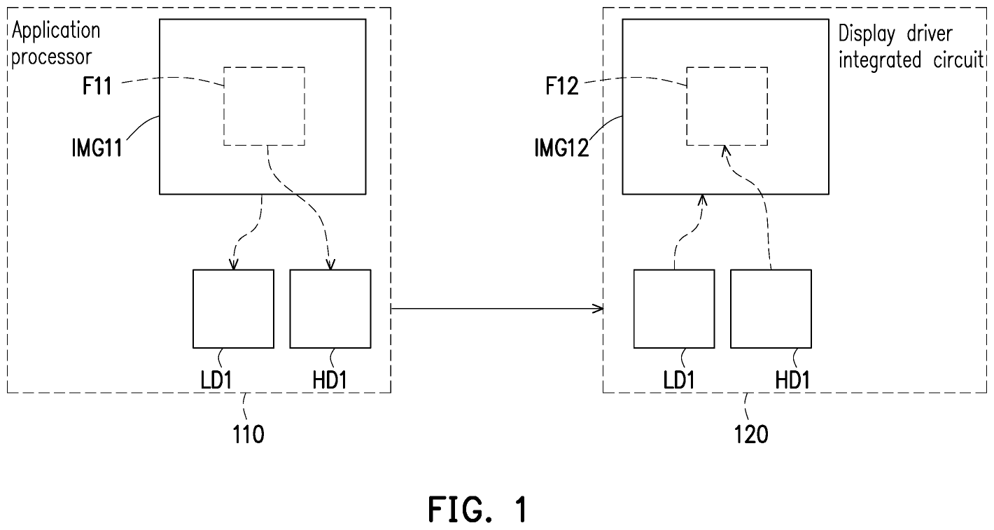

FIG. 2 is a schematic diagram of a circuit block of a display device according to an embodiment of the disclosure.

FIG. 3 is a schematic diagram of a flowchart of an operation method of an image processor according to an embodiment of the disclosure.

FIG. 4 is a schematic diagram of a time sequence of a transmitting circuit transmitting a first image (a cropped image) and a second image (a downscaled image) according to an embodiment of the disclosure.

FIG. 5 is a schematic diagram of a time sequence of a transmitting circuit transmitting a first image and a second image according to another embodiment of the disclosure.

FIG. 6 is a schematic diagram of a flowchart of an operation method of a display driver integrated circuit according to an embodiment of the disclosure.

FIG. 7 is a schematic diagram of a circuit block of a memory unit and a foveated rendering circuit shown in FIG. 2 according to an embodiment of the disclosure.

FIG. 8 is a schematic diagram of a circuit block of a foveated rendering circuit shown in FIG. 2 according to another embodiment of the disclosure.

### DETAILED DESCRIPTION OF DISCLOSED EMBODIMENTS

The term “coupling (or connection)” used in the entire specification (including the claims) of the present application may refer to any direct or indirect connection means. For example, if a first device is described as being coupled (or connected) to a second device, it should be interpreted that the first device may be directly connected to the second device or the first device may be indirectly connected to the second device through another device or certain connection means. Terms such as “first” and “second” mentioned in the entire specification (including the claims) of the present application are used to name the elements or to distinguish between different embodiments or ranges, but not to limit the upper limit or the lower limit of the quantity of elements or to limit the sequence of the elements. In addition, wherever possible, elements/components/steps using the same reference numerals in the drawings and embodiments represent the same or similar parts. Related descriptions of the elements/components/steps using the same reference numerals or using the same terminologies may be cross-referenced.

A data transmission method applied to a foveated rendering technology will be described below with some embodiments. In a case of limited interface bandwidth, the following embodiments can effectively reduce a latency.

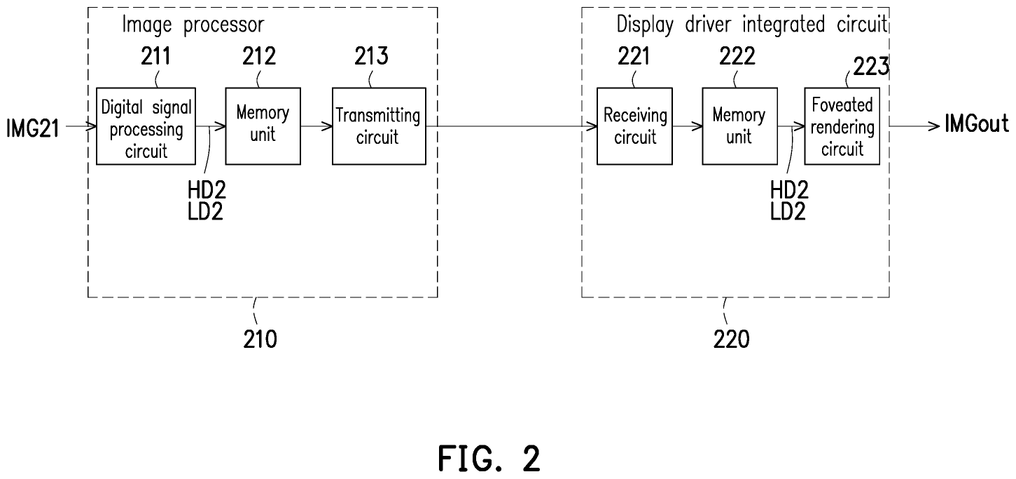

FIG. 2 is a schematic diagram of a circuit block of a display device according to an embodiment of the disclosure. The display device shown in FIG. 2 includes an image providing circuit (for example, an image processor 210) and a display driver integrated circuit 220. The image processor 210 includes a digital signal processing circuit 211, a memory unit 212, and a transmitting circuit 213. According to different design requirements, the implementations of the digital signal processing circuit 211 and/or the transmitting circuit 213 may be in the form of hardware, firmware, software (that is, program), or a combination of multiple of the above three. The image providing circuit may be an image processor such as a graphic processor, an application processor (AP), etc. which provides image data to the display driver integrated circuit 220.

In terms of the form of hardware, the digital signal processing circuit 211 and/or the transmitting circuit 213 may be implemented as logic circuits on an integrated circuit. Related functions of the digital signal processing circuit 211 and/or the transmitting circuit 213 may be implemented in hardware using hardware description languages (for example, Verilog HDL or VHDL) or other suitable programming languages. For example, the related functions of the digital signal processing circuit 211 and/or the transmitting circuit 213 may be implemented in one or more controllers, microcontrollers, microprocessors, application-specific integrated circuits (ASICs), digital signal processors (DSPs), field programmable gate arrays (FPGAs), and/or various logic blocks, modules, and circuits in other processing units.

In terms of the form of software and/or firmware, the related functions of the digital signal processing circuit 211 and/or the transmitting circuit 213 may be implemented as programming codes. For example, the digital signal processing circuit 211 and/or the transmitting circuit 213 are implemented using general programming languages (for example, C, C++, or assembly language) or other suitable programming languages. The programming codes may be recorded/stored in a “non-transitory readable medium”. For example, a disk, a card, a semiconductor memory, a programmable logic circuit, etc. may be used to implement the non-transitory readable medium. A central processing unit (CPU), a controller, a microcontroller, or a microprocessor may read and execute the programming codes from the recording medium, thereby implementing the related functions of the digital signal processing circuit 211 and/or the transmitting circuit 213.

The digital signal processing circuit 211 generates a first image and a second image based on an original image IMG21, wherein the first image is a cropped image HD2 with respect to a foveated area of the original image IMG21, and the second image is a downscaled image LD2 through scaling down the original image IMG21. The digital signal processing circuit 211 may define a foveated area in the original image IMG21. The digital signal processing circuit 211 may generated the cropped image HD2 by cropping out the foveated area of the original image IMG21. The digital signal processing circuit 211 may also scale down the original image IMG21 to generate a downscaled image LD2. The transmitting circuit 213 may transmit the downscaled image LD2 and the cropped image HD2 to the display driver integrated circuit 220. After the receiving circuit 221 of the display driver integrated circuit 220 receives and stores the downscaled image LD2 and the cropped image HD2, the foveated rendering circuit 223 may scale up the downscaled image LD2 to generate an upscaled image. The display driver integrated circuit 220 may merge or blend the cropped image HD1 into a foveated area of the upscaled image to generate an output image IMGout to be displayed.

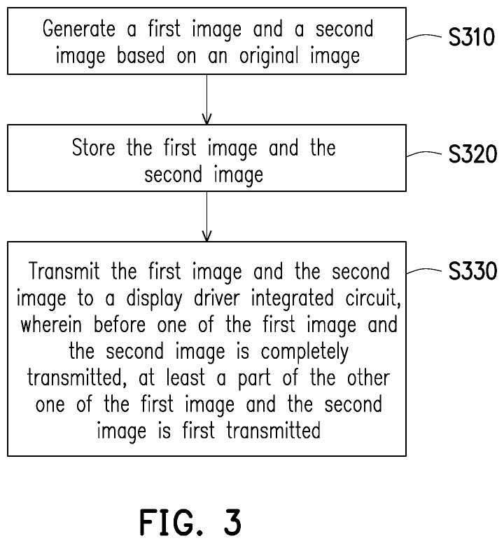

FIG. 3 is a schematic diagram of a flowchart of an operation method of an image processor according to an embodiment of the disclosure. Please refer to FIG. 2 and FIG. 3. In Step S310, the digital signal processing circuit 211 may generate a first image (the cropped image HD2) and a second image (the downscaled image LD2) based on the original image IMG21. For example, the digital signal processing circuit 211 may define a foveated area in the original image IMG21. The position and the size of the foveated area in the original image IMG21 may be defined according to the actual design. The digital signal processing circuit 211 may crop a cropped image HD2 from the foveated area of the original image IMG21.

In addition, in Step S310, the digital signal processing circuit 211 may also reduce the amount of data of the original image IMG21, that is, reduce the resolution of the original image IMG21 to generate the downscaled image LD2 (the second image). The resolution of the downscaled image LD2 may be determined according to the actual design. For example, but not limited to, the resolution (a.k.a. second resolution) of the downscaled image LD2 (the second image) may be the same as the resolution (a.k.a. first resolution) of the cropped image HD2 (the first image). In other words, the size of the downscaled image LD2 is the same as the size of the cropped image HD2.

The shown memory unit 212 is coupled to the digital signal processing circuit 211 to store the first image and the second image (Step S320). The transmitting circuit 213 is coupled to a receiving circuit 221 of the display driver integrated circuit 220. According to the actual implementation, the connection between the transmitting circuit 213 and the receiving circuit 221 may include a mobile industry processor interface (MIPI), a DisplayPort (DP) interface, an embedded DP (embedded DP, eDP) interface, or other transmission interfaces. In Step S330, the transmitting circuit 213 may transmit the first image (the cropped image HD2) and the second image (the downscaled image LD2) to the display driver integrated circuit 220. Amount of data transmitted can be significantly reduced by transmitting the second image and image detail displayed can be maintained as possible by transmitting the first image to the display driver integrated circuit 220.

In the embodiment shown in FIG. 2, the transmitting circuit 213 first transmits at least a part of one of the first image and the second image before the other one of the first image and the second image is completely transmitted. For example, the transmitting circuit 213 may alternately transmit multiple parts of the first image (the cropped image HD2) generated through partitioning the first image, a.k.a. multiple first partial images, and multiple parts of the second image (the downscaled image LD2) generated through partitioning the second image, a.k.a. multiple second partial images. The quantity of the parts of the first image and the quantity of the parts of the second image are not less than two. The transmitting circuit 213 is coupled to the memory unit 212 and alternately reads the cropped image HD2 and the downscaled image LD2 in time division from the memory unit 212. For example, each of the parts of the cropped image HD2 (the first image) includes at least one line of the cropped image HD2, and each of the parts of the downscaled image LD2 (the second image) includes at least one line of the downscaled image LD2.

In other words, the transmitting circuit 213 respectively transmits multiple first partial images of the cropped image HD2 (the first image) in multiple first transmitting time units, and respectively transmits multiple second partial images of the downscaled image LD2 (the second image) in multiple second transmitting time units. The first transmitting time units and the second transmitting time units are alternately arranged. Each of the first transmitting time units is long enough to transmit at least one line of the cropped image HD2 (the first image), and each of the second transmitting time units is long enough to transmit at least one line of the downscaled image LD2 (the second image). Therefore, the read cropped image HD2 and downscaled image LD2 may be transmitted to the display driver integrated circuit 220 in time division.

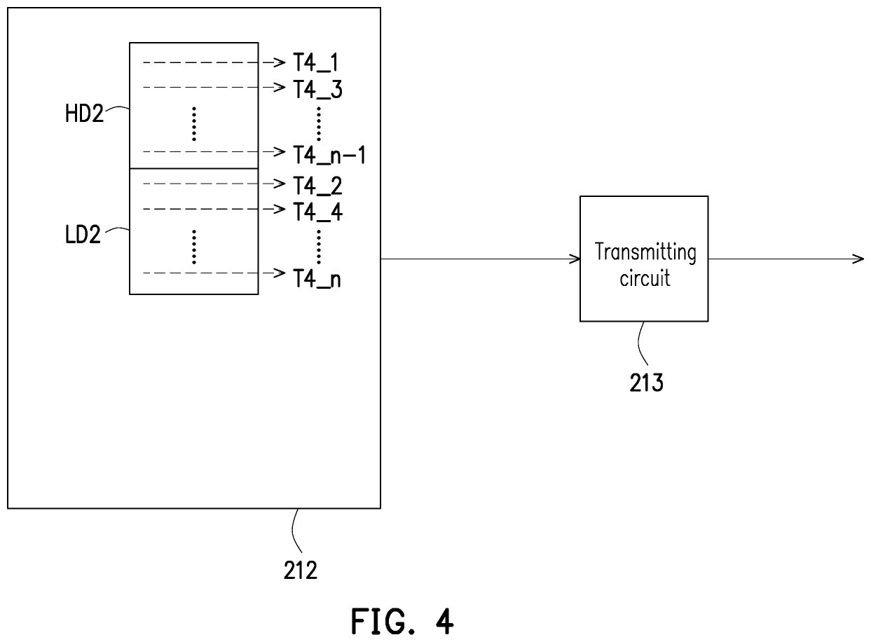

FIG. 4 is a schematic diagram of a time sequence of the transmitting circuit 213 transmitting the first image (the cropped image HD2) and the second image (the downscaled image LD2) according to an embodiment of the disclosure. Please refer to FIG. 2 and FIG. 4. The digital signal processing circuit 211 may store the cropped image HD2 and the downscaled image LD2 in the memory unit 212. A first memory space of the memory unit 212 is dedicated to storing the first partial images generated through partitioning the cropped image HD2. A second memory space of the memory unit 212 is dedicated to storing the second partial images generated through partitioning the downscaled image LD2. Each of the first partial images includes at least one line of the cropped image HD2, and each of the second partial images includes at least one line of the downscaled image LD2.

The transmitting circuit 213 may alternately read the first partial images of the cropped image HD2 and the second partial images of the downscaled image LD2 from the memory unit 212 in time division. T4_1, T4_2, T4_3, T4_4, ..., T4_n-1, and T4_n shown in FIG. 4 represent transmitting time units. In the transmission time unit T4_1, the transmitting circuit 213 may transmit a first part (for example, a first line) of the cropped image HD2 to the receiving circuit 221 of the display driver integrated circuit 220. In the transmission time unit T4_2 after transmission the time unit T4_1, the transmitting circuit 213 may transmit a first part (for example, a first line) of the downscaled image LD2 to the receiving circuit 221. In the transmission time unit T4_3 after the transmission time unit T4_2, the transmitting circuit 213 may transmit a second part (for example, a second line) of the cropped image HD2 to the receiving circuit 221. In the transmission time unit T4_4 after the transmission time unit T4_3, the transmitting circuit 213 may transmit a second part (for example, a second line) of the downscaled image LD2 to the receiving circuit 221. By analogy, the transmitting circuit 213 may transmit a last part (for example, a last line) of the cropped image HD2 to the receiving circuit 221 in the transmission time unit T4_n-1, and the transmitting circuit 213 may transmit a last part (for example, a last line) of the downscaled image LD2 to the receiving circuit 221 in the transmission time unit T4_n.

Therefore, the read cropped image HD2 and downscaled image LD2 may be transmitted to the display driver integrated circuit 220 in time division. After the transmission time unit T4_2, the display driver integrated circuit 220 may immediately scale up the first line of the downscaled image LD2 to generate multiple corresponding lines of the upscaled image, thereby starting to output a part of an output image IMGout to be displayed to a display panel (not shown). Therefore, before one of the cropped image HD2 and the downscaled image LD2 is completely transmitted to the display driver integrated circuit 220, the image processor 210 may first transmit at least a part of the other one of the cropped image HD2 and the downscaled image LD2 to the display driver integrated circuit 220. Based on this, the latency can be effectively reduced.

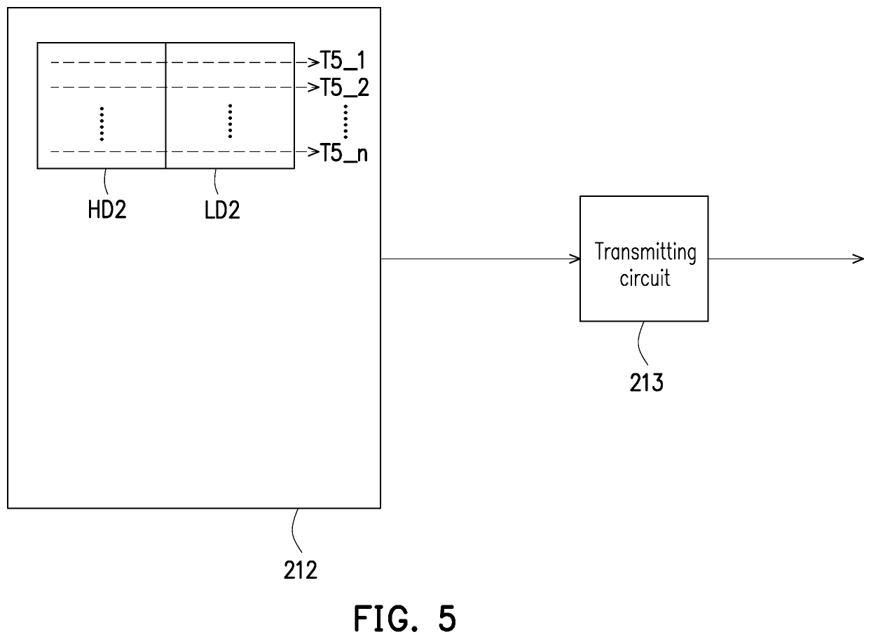

FIG. 5 is a schematic diagram of a time sequence of the transmitting circuit 213 transmitting the first image (the cropped image HD2) and the second image (the downscaled image LD2) according to another embodiment of the disclosure. Please refer to FIG. 2 and FIG. 5. The digital signal processing circuit 211 may store the cropped image HD2 and the downscaled image LD2 in the memory unit 212. Multiple continuous memory spaces of the memory unit 212 are configured to alternately store the first partial images generated through partitioning the cropped image HD2 and the second partial images generated through partitioning the downscaled image LD2, as shown in FIG. 5. Each of the first partial images includes at least one line of the cropped image HD2, and each of the second partial images includes at least one line of the downscaled image LD2.

The transmitting circuit 213 may alternately read the first partial images of the cropped image HD2 and the second partial images of the downscaled image LD2 from the memory unit 212 in time division. T5_1, T5_2, . . . , and T5_n shown in FIG. 5 represent transmission time units. In the transmission time unit T5_1, the transmitting circuit 213 may first transmit the first part (for example, the first line) of the cropped image HD2 and then transmit the first part (for example, the first line) of the downscaled image LD2 to the receiving circuit 221 of the display driver integrated circuit 220. In the transmission time unit T5_2 after the transmission time unit T5_1, the transmitting circuit 213 may first transmit the second part (for example, the second line) of the cropped image HD2 and then transmit the second part (for example, the second line) of the downscaled image LD2 to the receiving circuit 221. By analogy, the transmitting circuit 213 may first transmit the last part (for example, the last line) of the cropped image HD2 and then transmit the last part (for example, the last line) of the downscaled image LD2 to the receiving circuit 221 in the transmission time unit T5_n.

Therefore, the read cropped image HD2 and downscaled image LD2 may be transmitted to the display driver integrated circuit 220 in time division. After the transmission time unit T5_1, the display driver integrated circuit 220 may immediately scale up the first line of the downscaled image LD2 to generate the corresponding lines of the upscaled image, thereby starting to output the output image IMGout to be displayed to the display panel (not shown). Therefore, before one of the cropped image HD2 and the downscaled image LD2 is completely transmitted to the display driver integrated circuit 220, the image processor 210 may first transmit at least a part of the other one of the cropped image HD2 and the downscaled image LD2 to the display driver integrated circuit 220. Based on this, the latency can be effectively reduced.

In the embodiment shown in FIG. 2, the display driver integrated circuit 220 includes the receiving circuit 221, the memory unit 222, and a foveated rendering circuit 223. According to different design requirements, the implementations of the receiving circuit 221 and/or the foveated rendering circuit 223 may be in the form of hardware, firmware, software (program), or a combination of multiple of the above three.

In the form of hardware, the receiving circuit 221 and/or the foveated rendering circuit 223 may be implemented as logic circuits on an integrated circuit. Related functions of the receiving circuit 221 and/or the foveated rendering circuit 223 may be implemented in hardware using hardware description languages (for example, Verilog HDL or VHDL) or other suitable programming languages. For example, the related functions of the receiving circuit 221 and/or the foveated rendering circuit 223 may be implemented in one or more controllers, microcontrollers, microprocessors, application-specific integrated circuits (ASICs), digital signal processors (DSPs), field programmable gate arrays (FPGAs), and/or various logic blocks, modules, and circuits in other processing units.

In the form of software and/or firmware, the related functions of the receiving circuit 221 and/or the foveated rendering circuit 223 may be implemented as programming codes. For example, the receiving circuit 221 and/or the foveated rendering circuit 223 are implemented using general programming languages (for example, C, C++, or assembly language) or other suitable programming languages. The programming codes may be recorded/stored in a “non-transitory readable medium”. For example, a disk, a card, a semiconductor memory, a programmable logic circuit, etc. may be used to implement the non-transitory readable medium. A central processing unit (CPU), a controller, a microcontroller, or a microprocessor may read and execute the programming codes from the recording medium, thereby implementing the related functions of the receiving circuit 221 and/or the foveated rendering circuit 223.

The receiving circuit 221 may receive the first image (the cropped image HD2) and the second image (the downscaled image LD2) from the image providing circuit (for example, the image processor 210). The receiving circuit 221 receives at least a part of one of the first image and the second image before the other one of the first image and the second image is completely received. The time sequence of the receiving circuit 221 receiving the cropped image HD2 and the downscaled image LD2 from the image processor 210 is in accordance with the transmission time sequence of the image processor 210, and for the transmission time sequence of the image processor 210, reference may be made to the related descriptions of FIG. 4 or FIG. 5.

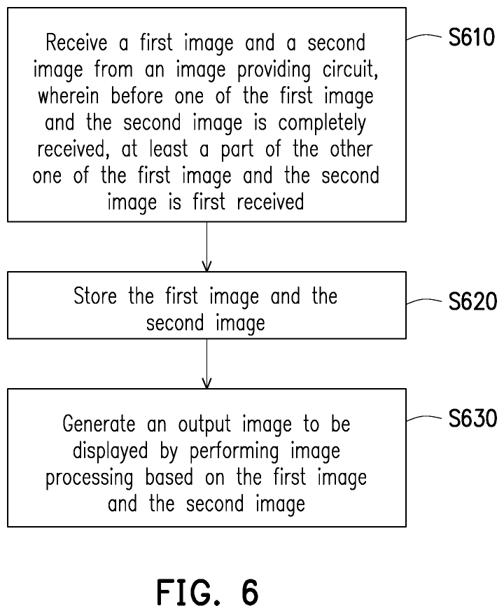

FIG. 6 is a schematic diagram of a flowchart of an operation method of a display driver integrated circuit according to an embodiment of the disclosure. Please refer to FIG. 2 and FIG. 6. In Step S610, the receiving circuit 221 may receive the first image (the cropped image HD2) and the second image (the downscaled image LD2) from the image providing circuit (for example, the image processor 210), wherein the receiving circuit 221 receives at least a part of one of the cropped image HD2 and the downscaled image LD2 before the other one of the cropped image HD2 and the downscaled image LD2 is completely received. In one embodiment, the receiving circuit 221 may alternately receive multiple parts of the cropped image HD2 and multiple parts of the downscaled image LD2, wherein the quantity of the parts of the cropped image HD2 and the quantity of the parts of the downscaled image LD2 are not less than two. For example, each of the parts of the cropped image HD2 includes at least one line of the cropped image HD2, and each of the parts of the downscaled image LD2 includes at least one line of the downscaled image LD2.

The receiving circuit 221 respectively receives multiple parts of the first image (the cropped image HD2), a.k.a. multiple first partial images, in multiple first receiving time units, and respectively receives multiple parts of the second image (the downscaled image LD2), a.k.a. multiple second partial images, in multiple second receiving time units, wherein the first receiving time units and the second receiving time units are alternately arranged. Each of the first receiving time units is long enough to receive at least one line of the cropped image HD2, and each of the second receiving time units is long enough to receive at least one line of the downscaled image LD2. The memory unit 222 is coupled to the receiving circuit 221 to store the first image (the cropped image HD2) and the second image (the downscaled image LD2) (Step S620). According to the actual implementation, in some examples, the resolution (a.k.a. first resolution) of the cropped image HD2 is the same as the resolution (a.k.a. second resolution) of the downscaled image LD2. In other examples, the resolution of the cropped image HD2 may be different from the resolution of the downscaled image LD2.

The foveated rendering circuit 223 is coupled to the memory unit 222. In Step S630, the foveated rendering circuit 223 generates the output image IMGout to be displayed by performing image processing based on the first image (the cropped image HD2) and the second image (the downscaled image LD2), wherein the first image is with respect to a foveated area of the output image IMGout. The resolution of the cropped image HD2 is different from the resolution (a.k.a. third resolution) of the output image IMGout.

Image processing performed by the foveated rendering circuit 223 based on the first image (the cropped image HD2) and the second image (the downscaled image LD2) is described below. First, the foveated rendering circuit 223 may scale up the downscaled image LD2 to generate an upscaled image. The foveated rendering circuit 223 may blend the cropped image HD2 and the upscaled image, and the cropped image HD2 is blended into a foveated area of the upscaled image to generate the output image IMGout. The resolution of the upscaled image is the same as the resolution of the output image IMGout. Image data of the foveated area of the output image IMGout may be different from image data of the foveated area of the original image in the image processor side.

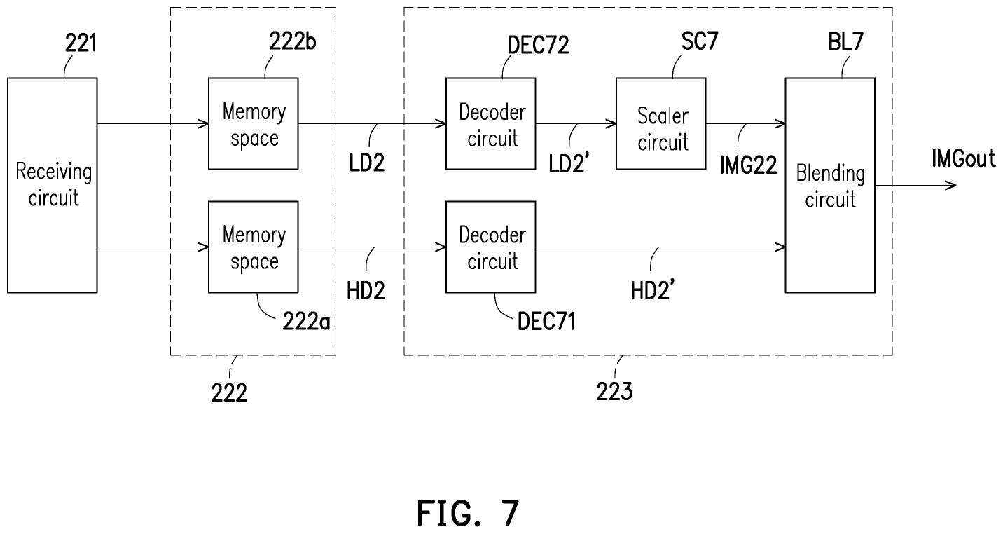

FIG. 7 is a schematic diagram of a circuit block of the memory unit 222 and the foveated rendering circuit 223 shown in FIG. 2 according to an embodiment of the disclosure. For the receiving circuit 221, the memory unit 222, and the foveated rendering circuit 223 shown in FIG. 7, reference may be made to the relevant descriptions of the receiving circuit 221, the memory unit 222, and the foveated rendering circuit 223 shown in FIG. 2, so there will be no repetition. In the embodiment shown in FIG. 7, the memory unit 222 includes a memory space 222a and a memory space 222b. The memory space 222a and the memory space 222b are separate spaces in the memory unit 222. The receiving circuit 221 is configured to receive the first partial images of the first image (the cropped image HD2) in the first receiving time units and store the first partial images to the memory space 222a of the memory unit 222, and to receive the second partial images of the second image (the downscaled image LD2) in the second receiving time units and store the second partial images to the memory space 222b of the memory unit 222.

In the embodiment shown in FIG. 7, the foveated rendering circuit 223 includes a decoder circuit DEC71, a decoder circuit DEC72, a scaler circuit SC7, and a blending circuit BL7. The decoder circuit DEC71 is coupled to the memory unit 222 to read the cropped image HD2 (the first image) from the memory space 222a. The decoder circuit DEC71 may decode the cropped image HD2 to generate a cropped image HD2′. The decoder circuit DEC72 is coupled to the memory unit 222 to read the downscaled image LD2 (the second image) from the memory space 222b. The decoder circuit DEC72 may decode the downscaled image LD2 to generate a downscaled image LD2′. The scaler circuit SC7 may scale up the decoded second image (the downscaled image LD2′) to generate an up scaled image IMG22. The blending circuit BL7 may blend the cropped image HD2′ and the upscaled image IMG22 to generate the output image IMGout.

The above operations such as data upscaling, blending, and outputting the upscaled image may be performed on horizontal display lines. That is, the data upscaling/blending operation may be performed without waiting for a complete source image frame to be received. After receiving the first line of the downscaled image, the display driver integrated circuit 220 may start to generate a first line of the output image IMGout to be displayed to the display panel (not shown). Therefore, the latency can be effectively shortened.

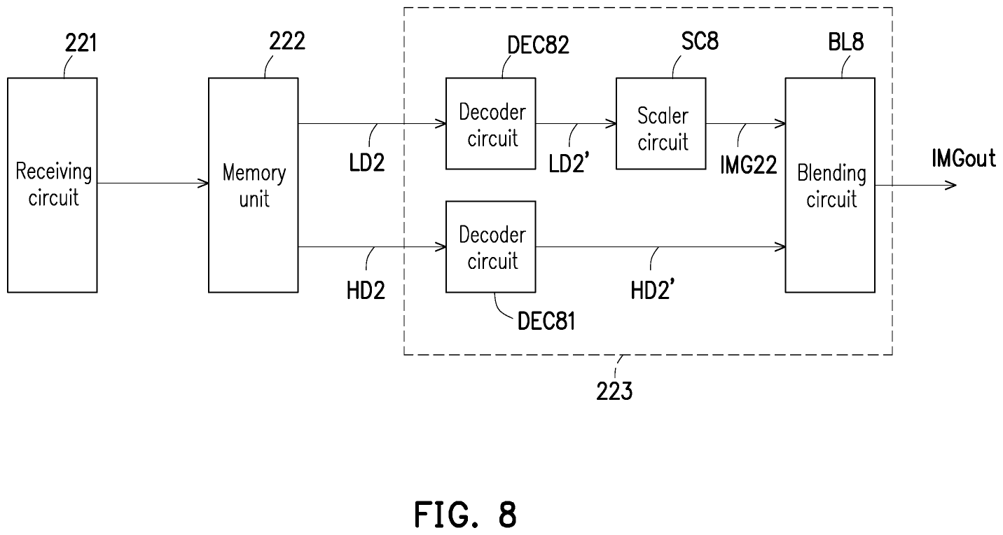

FIG. 8 is a schematic diagram of a circuit block of the foveated rendering circuit 223 shown in FIG. 2 according to another embodiment of the disclosure. For the receiving circuit 221, the memory unit 222, and the foveated rendering circuit 223 shown in FIG. 8, reference may be made to the relevant descriptions of the receiving circuit 221, the memory unit 222, and the foveated rendering circuit 223 shown in FIG. 2, so there will be no repetition. In the embodiment of FIG. 8, there is no continuous memory space dedicated to storing the first partial images or the second partial images.

In the embodiment shown in FIG. 8, the receiving circuit 221 is configured to store the first partial images of the first image (the cropped image HD2) respectively received by the receiving circuit 221 in the first receiving time units to the memory unit 222, and to store the second partial images of the second image (the downscaled image LD2) respectively received by the receiving circuit 221 in the second receiving time units to the memory unit 222.

The foveated rendering circuit 223 shown in FIG. 8 includes a decoder circuit DEC81, a decoder circuit DEC82, a scaler circuit SC8, and a blending circuit BL8. For the decoder circuit DEC81, the decoder circuit DEC82, the scaler circuit SC8, and the blending circuit BL8 shown in FIG. 8, reference may be made to the relevant descriptions of the decoder circuit DEC71, the decoder circuit DEC72, the scaler circuit SC7, and the blending circuit BL7 shown in FIG. 7, so there will be no repetition.

The decoder circuits DEC81 and DEC82 are coupled to the memory unit 222. In the embodiment shown in FIG. 8, the decoder circuit DEC 81 is configured to access multiple first designated spaces respectively storing the first partial images of the first image (the cropped image HD2) in the memory unit 222. The decoder circuit DEC81 may decode the cropped image HD2, and output the cropped image HD2′ (the first image) after being decoded. The decoder circuit DEC 82 is configured to access multiple second designated spaces respectively storing the second partial images of the second image (the downscaled image LD2) in the memory unit 222. The decoder circuit DEC82 may decode the downscaled image LD2, and output the downscaled image LD2′ (the second image) after being decoded.

In summary, the image providing circuit (for example, the image processor) according to the embodiments of the disclosure may generate the cropped image (the first image) and the downscaled image (the second image) based on the original image. The image processor may first transmit at least a part of one of the cropped image and the downscaled image to the display driver integrated circuit before the other one of the cropped image and the downscaled image is completely transmitted to the display driver integrated circuit. Therefore, the latency can be effectively reduced.

Although the disclosure has been disclosed in the above embodiments, the embodiments are not intended to limit the disclosure. Persons skilled in the art may make some changes and modifications without departing from the spirit and scope of the disclosure. The protection scope of the disclosure shall be defined by the appended claims.

What is claimed is:

1. A display driver integrated circuit, comprising:
a receiving circuit, configured to receive a first image and a second image from an image providing circuit;
a memory unit, configured to store the first image and the second image; and
a foveated rendering circuit, coupled to the memory unit and configured to generate an output image to be displayed by performing image processing based on the first image and the second image, wherein the first image is with respect to a foveated area of the output image,
wherein the receiving circuit receives at least a part of one of the first image and the second image before other one of the first image and the second image is completely received.

2. The display driver integrated circuit according to claim 1, wherein a first resolution of the first image is same as a second resolution of the second image.

3. The display driver integrated circuit according to claim 1, wherein a first resolution of the first image is different from a third resolution of the output image.

4. The display driver integrated circuit according to claim 1, wherein the foveated rendering circuit performing the image processing based on the first image and the second image comprises:
scaling up the second image to generate an upscaled image; and
blending the first image and the upscaled image to generate the output image, wherein the first image is blended into the foveated area of the output image.

5. The display driver integrated circuit according to claim 4, wherein a resolution of the upscaled image is same as a resolution of the output image.

6. The display driver integrated circuit according to claim 4, wherein the foveated rendering circuit comprises:
a scaler circuit, configured to scale up the second image to generate the upscaled image; and
a blending circuit, configured to blend the first image and the upscaled image to generate the output image.

7. The display driver integrated circuit according to claim 4, wherein the foveated rendering circuit comprises:
a first decoder circuit, coupled to the memory unit and configured to decode the first image; and
a second decoder circuit, coupled to the memory unit and configured to decode the second image,
wherein the foveated rendering circuit scales up the second image after being decoded to generate the upscaled image, and blends the first image after being decoded and the upscaled image to generate the output image.

8. The display driver integrated circuit according to claim 1, wherein the receiving circuit alternately receives a plurality of parts of the first image and a plurality of parts of the second image, wherein a quantity of the parts of the first image and a quantity of the parts of the second image are not less than two.

9. The display driver integrated circuit according to claim 8, wherein each of the parts of the first image comprises at least one line of the first image, and each of the parts of the second image comprises at least one line of the second image.

10. The display driver integrated circuit according to claim 1, wherein the receiving circuit is configured to respectively receive a plurality of parts of the first image in a plurality of first receiving time units, and respectively receive a plurality of parts of the second image in a plurality of second receiving time units, wherein the first receiving time units and the second receiving time units are alternately arranged.

11. The display driver integrated circuit according to claim 10, wherein each of the first receiving time units is long enough to receive at least one line of the first image, and each of the second receiving time units is long enough to receive at least one line of the second image.

12. The display driver integrated circuit according to claim 10, wherein the receiving circuit is further configured to store the plurality of parts of the first image respectively received by the receiving circuit in the first receiving time units to a first memory space of the memory unit, and to store the plurality of parts of the second image respectively received by the receiving circuit in the second receiving time units to a second memory space of the memory unit.

13. The display driver integrated circuit according to claim 12, wherein the first memory space and the second memory space are separate spaces in the memory unit.

14. The display driver integrated circuit according to claim 10, wherein the receiving circuit is further configured to store the plurality of parts of the first image respectively received by the receiving circuit in the first receiving time units to the memory unit, and to store the plurality of parts of the second image respectively received by the receiving circuit in the second receiving time units to the memory unit.

15. The display driver integrated circuit according to claim 14, wherein the foveated rendering circuit comprises:
a first decoder circuit, coupled to the memory unit and configured to access a plurality of first designated spaces storing the first partial images in the memory unit, and output the first image after being decoded; and
a second decoder circuit, coupled to the memory unit and configured to access a plurality of second designated spaces storing the second partial image in the memory unit, and output the second image after being decoded.

16. An operation method of a display driver integrated circuit, comprising:
receiving, by a receiving circuit of a display driver integrated circuit, a first image and a second image from an image providing circuit, wherein the receiving circuit receives at least a part of one of the first image and the second image before other one of the first image and the second image is completely received;
storing the first image and the second image to a memory unit: and
generating an output image to be displayed by performing image processing based on the first image and the second image, wherein the first image is with respect to a foveated area of the output image.

17. The operation method according to claim 16, wherein a first resolution of the first image is same as a second resolution of the second image.

18. The operation method according to claim 16, wherein a first resolution of the first image frame is different from a third resolution of the output image.

19. The operation method according to claim 16, wherein the image processing comprises:
scaling up the second image frame to generate an upscaled image; and
blending the first image and the upscaled image to generate the output image, wherein the first image is blended into a foveated area of the output image.

20. The operation method according to claim 19, wherein a resolution of the upscaled image is same as a resolution of the output image.

21. The operation method according to claim 19, further comprising:
upscaling, by a scaler circuit, the second image to generate the upscaled image; and
blending, by a blending circuit, the first image and the upscaled image to generate the output image.

22. The operation method according to claim 19, further comprising:
decoding, by a first decoder circuit, the first image; and
decoding, by a second decoder circuit, the second image.

23. The operation method according to claim 16, further comprising:
alternately receiving, by the receiving circuit, a plurality of parts of the first image and a plurality of parts of the second image, wherein a quantity of the parts of the first image and a quantity of the parts of the second image are not less than two.

24. The operation method according to claim 23, wherein each of the parts of the first image comprises at least one line of the first image, and each of the parts of the second image comprises at least one line of the second image.

25. The operation method according to claim 16, further comprising:
respectively receiving, by the receiving circuit, a plurality of parts of the first image in a plurality of first receiving time units; and
respectively receiving, by the receiving circuit, a plurality of parts of the second image in a plurality of second receiving time units, wherein the first receiving time units and the second receiving time units are alternately arranged.

26. The operation method according to claim 25, wherein each of the first receiving time units is long enough to receive at least one line of the first image, and each of the second receiving time units is long enough to receive at least one line of the second image.

27. The operation method according to claim 25, further comprising:
storing the plurality of parts of the first image respectively received by the receiving circuit in the first receiving time units to a first memory space of the memory unit; and
storing plurality of parts of the second image respectively received by the receiving circuit in the second receiving time units to a second memory space of the memory unit.

28. The operation method according to claim 27, wherein the first memory space and the second memory space are separate spaces in the memory unit.

29. The operation method according to claim 25, further comprising:
storing the plurality of parts of the first image respectively received by the receiving circuit in the first receiving time units to the memory unit; and
storing the plurality of parts of the second image respectively received by the receiving circuit in the second receiving time units to the memory unit.

30. The operation method according to claim 29, further comprising:
accessing, by a first decoder circuit, a plurality of first designated spaces storing the plurality of parts of the first image in the memory unit, and outputting the first image after being decoded; and
accessing, by a second decoder circuit, a plurality of second designated spaces storing the plurality of parts of the second image in the memory unit, and outputting the second image after being decoded.

31. An image processor, comprising:
a digital signal processing circuit, configured to generate a first image and a second image based on an original image, wherein the first image is a cropped image with respect to a foveated area of the original image, and the second image is a downscaled image through scaling down the original image;
a memory unit, coupled to the digital signal processing circuit and configured to store the first image and the second image; and
a transmitting circuit, coupled to the memory unit and configured to transmit the first image and the second image to a display driver integrated circuit, wherein the transmitting circuit transmits at least a part of one of the first image and the second image before other one of the first image and the second image is completely transmitted.

32. The image processor according to claim 31, wherein a first resolution of the first image is same as a second resolution of the second image.

33. The image processor according to claim 31, wherein the transmitting circuit alternately transmits a plurality of parts of the first image and a plurality of parts of the second image, wherein a quantity of the parts of the first image and a quantity of the parts of the second image are not less than two.

34. The image processor according to claim 33, wherein each of the parts of the first image comprises at least one line of the first image, and each of the parts of the second image comprises at least one line of the second image.

35. The image processor according to claim 31, wherein the transmitting circuit is configured to respectively transmit a plurality of parts of the first image in a plurality of first transmitting time units, and respectively transmit a plurality of parts of the second image in a plurality of second transmitting time units, wherein the first transmitting time units and the second transmitting time units are alternately arranged.

36. The image processor according to claim 35, wherein each of the first transmitting time units is long enough to transmit at least one line of the first image, and each of the second transmitting time units is long enough to transmit at least one line of the second image.

37. The image processor according to claim 31, wherein the digital signal processing circuit is further configured to store the first image and the second image to the memory unit, wherein a plurality of continuous memory spaces of the memory unit are configured to alternately store a plurality of parts of the first image generated through partitioning the first image and a plurality of parts of the second image generated through partitioning the second image, wherein each of the plurality of parts of the first image comprises at least one line of the first image, and each of the plurality of parts of the second image comprises at least one line of the second image.

38. The image processor according to claim 31, wherein the digital signal processing circuit is further configured to store the first image and the second image to the memory unit, wherein a first memory space of the memory unit is dedicated to storing a plurality of parts of the first image generated through partitioning the first image, and a second memory space of the memory unit is dedicated to storing a plurality of parts of the second image generated through partitioning the second image, wherein each of the plurality of parts of the first image comprises at least one line of the first image, and each of the plurality of parts of the second image comprises at least one line of the second image.

39. An operation method of an image processor, comprising:
generating, by a digital signal processing circuit of the image processor, a first image and a second image based on an original image, wherein the first image is a cropped image with respect to a foveated area of the original image, and the second image is a downscaled image through scaling down the original image;
storing, by a memory unit of the image processor, the first image and the second image; and
transmitting, by a transmitting circuit of the image processor, the first image and the second image to a display driver integrated circuit, wherein the transmitting circuit transmits at least a part of one of the first image and the second image before other one of the first image and the second image is completely transmitted.

40. The operation method according to claim 39, wherein a first resolution of the first image is same as a second resolution of the second image.

41. The operation method according to claim 39, further comprising:
alternately transmitting, by the transmitting circuit, a plurality of parts of the first image and a plurality of parts of the second image, wherein a quantity of the parts of the first image and a quantity of the parts of the second image are not less than two.

42. The operation method according to claim 41, wherein each of the parts of the first image comprises at least one line of the first image, and each of the parts of the second image comprises at least one line of the second image.

43. The operation method according to claim 39, further comprising:
respectively transmitting a plurality of parts of the first image in a plurality of first transmitting time units; and
respectively transmitting a plurality of parts of the second image in a plurality of second transmitting time units, wherein the first transmitting time units and the second transmitting time units are alternately arranged.

44. The operation method according to claim 43, wherein each of the first transmitting time units is long enough to transmit at least one line of the first image, and each of the second transmitting time units is long enough to transmit at least one line of the second image.

45. The operation method according to claim 39, wherein a plurality of continuous memory spaces of the memory unit are configured to alternately store a plurality of parts of the first image generated through partitioning the first image and a plurality of parts of the second image generated through partitioning the second image, each of the plurality of parts of the first image comprises at least one line of the first image, and each of the plurality of parts of the second image comprises at least one line of the second image.

46. The operation method according to claim 39, wherein a first memory space of the memory unit is dedicated to storing a plurality of parts of the first image generated through partitioning the first image, a second memory space of the memory unit is dedicated to storing a plurality of parts of the second image generated through partitioning the second image, each of the plurality of parts of the first image comprises at least one line of the first image, and each of the plurality of parts of the second image comprises at least one line of the second image.
